(19) United States
(12) Patent Application Publication
(10) Pub. No.: US 2025/0322597 A1
(43) Pub. Date: Oct. 16, 2025

(54) MULTIFOCAL ASSEMBLY FOR EXTENDED REALITY DEVICES

(71) Applicant: Snap Inc., Santa Monica, CA (US)

(72) Inventors: Alexander Plopski, Graz (AT); Christoph Ebner, Graz (AT)

(21) Appl. No.: 18/636,530

(22) Filed: Apr. 16, 2024

(51) Int. Cl. G06T 17/00; G02B 3/10; G02B 27/01

(52) U.S. Cl. CPC G06T 17/00; G02B 3/10; G02B 27/0172

(57) ABSTRACT

A head-wearable extended reality (XR) device includes an optical assembly. The optical assembly has a display and an optical element. The display is provided to display virtual content to a user of the XR device. The optical element is provided to direct the virtual content from the display along an optical path to an eye of the user. The optical element includes a first portion and a second portion. The first portion provides a first focus distance that corresponds to a first viewing zone of the display. The second portion provides a second focus distance that differs from the first focus distance and corresponds to a second viewing zone of the display.

### TECHNICAL FIELD

Subject matter disclosed herein relates, generally, to extended reality (XR). More specifically, but not exclusively, the subject matter relates to a multifocal assembly for an XR device.

### BACKGROUND

The field of XR continues to grow. Some XR devices are able to overlay virtual content onto, or mix virtual content into, a user's perception of reality, providing a user experience that can be entertaining, informative, or useful.

### BRIEF DESCRIPTION OF THE SEVERAL VIEWS OF THE DRAWINGS

In the drawings, which are not necessarily drawn to scale, like numerals may describe similar components in different views. To identify the discussion of any particular element or act more easily, the most significant digit or digits in a reference number refer to the figure number in which that element is first introduced. Some non-limiting examples are illustrated in the figures of the accompanying drawings in which:

FIG. 1 is a block diagram illustrating a network environment for operating an XR device, according to some examples.

FIG. 2 is a block diagram illustrating components of an XR device, according to some examples.

FIG. 3 is a diagrammatic top view illustration of a first image plane and a second image plane associated with an XR device worn by a user, according to some examples.

FIG. 4 is a diagrammatic side view illustration of a manner in which an optical assembly that includes a focusing lens can be used to generate virtual content to be perceived clearly at a first image plane and at a second image plane, respectively, associated with an XR device worn by a user, according to some examples.

FIG. 5 is a diagrammatic illustration of a field of view of a user wearing an XR device, where the user focuses on virtual content in a near-view zone, according to some examples.

FIG. 6 is another diagrammatic illustration of the field of view of FIG. 5, where the user focuses on virtual content in a far-view zone, according to some examples.

FIG. 7 is a flowchart illustrating a method suitable for displaying virtual content at different focus distances via an XR device, according to some examples.

FIG. 8 illustrates a network environment in which a head-wearable apparatus can be implemented, according to some examples.

FIG. 9 is a block diagram showing a software architecture within which the present disclosure may be implemented, according to some examples.

FIG. 10 is a diagrammatic representation of a machine in the form of a computer system within which a set of instructions may be executed for causing the machine to perform any one or more of the methodologies discussed herein, according to some examples.

### DETAILED DESCRIPTION

The description that follows describes systems, methods, techniques, instruction sequences, and computing machine program products that illustrate examples of the present subject matter. In the following description, for purposes of explanation, numerous specific details are set forth to provide an understanding of various examples of the present subject matter. It will be evident, however, to those skilled in the art, that examples of the present subject matter may be practiced without some or other of these specific details. Examples merely typify possible variations. Unless explicitly stated otherwise, structures (e.g., hardware structures) are optional and may be combined or subdivided, and operations (e.g., in a procedure, algorithm, or other function) may vary in sequence or be combined or subdivided.

The field of XR includes augmented reality (AR) and virtual reality (VR). AR may include an interactive experience of a real-world environment where physical objects or environments that reside in the real world are “augmented” or enhanced by computer-generated digital content (also referred to as virtual content). AR may include a system that enables a combination of real and virtual worlds, real-time interaction, and three-dimensional (3D) presentation of virtual and real objects. A user of an AR system may perceive virtual content that appears to be attached or interact with a real-world physical object. In some examples, AR overlays digital content on the real world. Alternatively, or additionally, AR combines real-world and digital elements. The term “AR” may thus include mixed reality experiences. The term “AR application” is used herein to refer to a computer-operated application that enables an AR experience.

VR may include a simulation experience of a virtual-world environment that is distinct from the real-world environment. Computer-generated digital content is displayed in the virtual-world environment. VR may also refer to a system that enables a user to be completely immersed in the virtual-world environment and to interact with virtual objects presented in the virtual-world environment. While examples described in the present disclosure focus primarily on XR devices that provide an AR experience, it will be appreciated that at least some aspects of the present disclosure may also be applied to VR.

A “user session” is used herein to refer to an operation of a device or application during periods of time. For example, a user session can include an operation of an AR application executing on a head-wearable XR device between the time the user puts on the XR device and the time the user takes off the head-wearable device. In some examples, a user session starts when an XR device is turned on or is woken up from sleep mode and stops when the XR device is turned off or placed in sleep mode. In other examples, the user session starts when the user runs or starts an AR application, or runs or starts a particular feature of the AR application, and stops when the user ends the AR application or stops the particular feature of the AR application.

A head-wearable XR device can display virtual content in different ways. For example, head-wearable AR devices can be categorized as having optical see-through (OST) displays or video pass-through (VPT) displays. In OST technologies, a user views the physical environment directly through transparent or semi-transparent display components, and virtual content can be rendered to appear as part of, or overlaid upon, the physical environment. In VPT technologies, a view of the physical environment is captured by one or more cameras and then presented to the user on an opaque display (e.g., in combination with virtual content). While examples described in the present disclosure focus primarily on OST displays, it will be appreciated that aspects of the present disclosure may also be applied to other types of displays, such as VPT displays.

Vergence and accommodation are two separate visual processes. Vergence refers to the movement of the eyes to maintain binocular vision, while accommodation refers to adjustment of an eye's lens to focus on objects at different distances. In natural viewing conditions, vergence and accommodation work together to enable a human to see objects clearly and without discomfort.

Vergence-accommodation conflict (VAC) is a problem experienced by users of at least some XR devices. Conventional XR devices may use a single image plane that is located at a predetermined distance in front of the user. As used herein, the term “image plane” refers to the virtual surface upon which digital content is projected or rendered from the user's viewing perspective. For example, if a user is viewing a virtual apple through a head-wearable XR device, the image plane associated with the virtual apple is the location in space where the apple appears sharp and clear.

The fixed focus distance of a conventional XR device may cause a mismatch between vergence and accommodation, leading to issues such as discomfort, visual strain, blurred perception, cybersickness, or visual fatigue. The VAC may also be associated with technical inconsistencies in the appearance of virtual content. For example, in an AR device, if the image plane is located at two meters from the user's eyes and the XR device renders a virtual apple on the user's outstretched hand (which is closer than two meters from the user's eyes), the apple may appear blurred when the user focuses on the hand, but sharp when the user focuses on the image plane, in conflict with the appearance of the hand.

One approach to mitigating the VAC involves dynamically adjusting the image plane. For example, an XR device can identify, measure, or estimate the focus distance or a desired focus distance, and then shift the image plane accordingly using a varifocal mechanism. The varifocal mechanism can, for example, dynamically adjust the power of a focusing lens or shift the position of the lens relative to a display to shift the image plane. However, this typically requires precise focus measurements or estimations, which can be difficult to obtain. For example, eye tracking errors can cause the XR device to shift the image plane to an incorrect position, leading to a loss of contrast and failing to address the VAC. Moreover, users may experience visual inconsistencies as a result of dynamic image plane shifting. The use of a varifocal mechanism in an XR device may also necessitate additional parts or more computations.

Another approach involves using a multilayer configuration to generate multiple image planes at different focus distances. However, this approach necessitates additional components and can involve a complex setup, such as a plurality of display layers operating together with a plurality of optical combiners. Furthermore, the use of multiple optical combiners can result in discoloration and distortions.

Multilayer light field displays have also been proposed. Multilayer light field displays emit directional light and thus show virtual content at different depths. However, such displays may exhibit poor brightness and/or poor contrast, and their working volume may be limited by diffraction effects. A multilayer light field configuration also involves additional components, such as stacked liquid-crystal display (LCD) layers that define the working volume.

Many XR devices are portable, making it desirable to conserve resources. Additional components used to combat the VAC, such as those referred to above, can increase power consumption and reduce battery life.

Examples described herein address or alleviate the VAC by providing a fixed optical assembly configured to present virtual content at multiple focus distances. Virtual content rendered by an XR device is displayed at different focus distances depending on a viewing zone of a display of the XR device.

In some examples, an accommodation-supporting device is provided through the incorporation of a multifocal assembly. The term “multifocal,” as used herein, may include an optical component or system designed to provide multiple distinct focus distances. In the context of an XR device, a multifocal optical element enables the presentation of virtual content at multiple perceived distances, enhancing the user's visual experience by allowing for clear focus across different depths. A multifocal lens may be a bifocal lens, a trifocal lens, a progressive lens providing a gradual transition or shift between focal powers, or another type of lens that provides multiple distinct focus distances.

Examples in the present disclosure leverage the observation that, when a user is experiencing AR, virtual content presented in a lower section of a field of view will likely be viewed with nearby real-world objects (e.g., when the user of a head-wearable XR device is performing hand-based interactions). Virtual content rendered in the lower section may thus be rendered at an image plane that is closer to the user than an image plane used to render virtual content in an upper section of the field of view, thereby addressing discrepancies between depth of content and background location.

An optical assembly of an XR device may include a display and an optical element. The display is provided to display virtual content for presentation to a user of the XR device. The optical element is provided to direct the virtual content from the display along an optical path towards an eye of the user. The optical assembly may be for one or both eyes of the user. Accordingly, in some cases, the optical assembly is a first optical assembly and the eye of the user is a first eye of the user, and the XR device further includes a second optical assembly for a second eye of the user. The second optical assembly may be similar to the first optical assembly.

The optical element may comprise multiple portions. In some examples, the optical element is a single, fixed element comprising at least a first portion and a second portion, with the first portion providing a first focus distance that corresponds to a first viewing zone of the display and the second portion providing a second focus distance that differs from the first focus distance and corresponds to a second viewing zone of the display.

The first portion may direct and focus light originating from the display such that the virtual content directed thereby is presented at a first image plane (e.g., located the first focus distance relative to the XR device), while the second portion directs and focuses light originating from the display such that the virtual content directed thereby is presented at a second image plane (e.g., located the second focus distance relative to the XR device). In some examples, the first focus distance and the second focus distance are fixed distances. Accordingly, a fixed multifocal assembly may be provided that does not require image plane adjustment during operation.

The optical element may be a focusing lens. Accordingly, the focusing lens may have multiple areas providing varying focus distances. In this way, content rendered on the display of the XR device is presented at different focus distances for the user based on the area or part of the display they are rendered in. This area or part may be referred to as the “viewing zone.”

As used herein, a “focus distance” refers to the distance over which light rays converge to form a sharp image of an object after passing through an optical element, such as a lens. In the context of displaying virtual images, the focus distance is the distance at which virtual images appear sharp and clear. A “viewing zone” as used herein, may include a specific region of a display designated for presenting virtual content at a specific focus distance. For example, in a bifocal lens setup, the viewing zone at a bottom region of the display of the XR device may be aligned with a near-focus area of the lens for displaying content that should appear close to the user, while the viewing zone at the top of the display may be aligned with a far-focus area for content that should appear at a greater distance.

Where the optical element is a lens, examples described herein provide for the use of different types of multifocal lenses, such as a bifocal focusing lens, a trifocal focusing lens, or a progressive focusing lens.

In the case of a trifocal focusing lens, for example, in addition to the first portion and the second portion mentioned above, the lens can further include a third portion providing a third focus distance that corresponds to a third viewing zone of the display, with the third focus distance differing from both the first focus distance and the second focus distance. In the case of a progressive focusing lens, for example, the lens may further include a plurality of portions, each providing a different focus distance that corresponds to a respective viewing zone of the display.

In this way, an XR device may provide multiple focus distances distributed (e.g., mapped) across a field of view according to a predetermined configuration. In some examples, focus distances are spread across the field of view according to a gradient. In some examples, more distinct steps are provided between viewing zones (e.g., in a bifocal setup).

In some examples, the lens is arranged in a fixed position relative to the display. The lens may be a fixed-focus focusing lens (e.g., the focusing power of the lens is not adjustable during operation).

The virtual content rendered on the display may include first virtual content and second virtual content. For example, the display can simultaneously display the first virtual content in the first viewing zone and the second virtual content in the second viewing zone. The optical assembly of the XR device is configured to direct, via the optical element, the first virtual content to be displayed at the first focus distance and the second virtual content to be displayed at the second focus distance. In other words, light representing the first virtual content is directed through the first portion of the XR device and light representing the second virtual content is directed through the second portion of the XR device.

The virtual content may include at least one virtual object. The XR device may include a processor to determine a presentation distance associated with the virtual object, and assign, based on the presentation distance, a matching focus distance to the virtual object. In response to the assignment of the focus distance to the virtual object, the XR device may cause the virtual object to be rendered in a viewing zone of the display that is associated with the focus distance for the virtual object. In this context, the term “presentation distance” may include the perceived or intended distance from the user at which virtual content is to be displayed within an XR environment (e.g., according to instructions received via an AR application and/or data describing the positions of objects in a real-world environment).

As mentioned above, from the viewing perspective of the user, the first viewing zone may be located in a lower section of a field of view, while the second viewing zone is located in an upper section of the field of view. The first viewing zone may thus provide virtual content at the first focus distance (e.g., a closer distance selected for hand-based interactions with the XR device, such as the presentation of a virtual apple on the hand), and the second viewing zone may provide virtual content at the second focus distance (e.g., a distance that is greater than the first distance, such as for presentation of a virtual scoreboard at a sporting event).

An XR device, according to some examples, is designed to enhance the visual experience of the user by providing the ability to perceive virtual content at multiple focus distances without requiring real-time image plane adjustment during a user session. A multifocal approach may address certain VAC-related challenges by allowing for natural focus transitions between virtual objects positioned at different depths within the field of view, closely mimicking the dynamic focusing capability of the human eye.

In some examples, a focusing lens of the optical assembly features regions with varying focal characteristics (e.g., powers), enabling the presentation of virtual content at near, intermediate, and/or far distances. This design may allow users to engage with intricate virtual details up close, interact with content at arm's length, and/or observe distant virtual landscapes, all with focus and without the need for varifocal adjustment or multilayer displays. Viewing zones of a display can be strategically designed to coincide with the user's natural gaze direction for different types of content, such as reading text at a lower angle versus viewing the environment at eye level, and virtual content can be rendered accordingly. As a result, reduced visual fatigue with prolonged use of XR devices may be facilitated.

Examples described herein may obviate the need for complex varifocal mechanisms that require precise focus measurements or estimations. For example, a fixed multifocal assembly may reduce the need to use eye tracking systems and avoid a significant loss of contrast and visual inconsistencies that can arise from shifting an image plane during operation. In some examples of the present disclosure, the need to perform eye tracking (e.g., gaze estimation) for image plane or content depth estimation is therefore obviated or reduced.

An optical assembly as described herein may also provide a simplified and more lightweight design, both from a mechanical and a computational perspective. As a result, manufacturing and computational costs can be reduced. For example, by avoiding the use of multiple, stacked display layers, an XR device may be produced at a lower cost while also improving its computational efficiency and/or battery life.

Examples described herein may enable an XR device to provide clear, high-quality, and high-contrast imagery without having to integrate complex optical arrangements, such as light field displays. Virtual content may be rendered with clarity across a range of depths while also providing a simplified optical design. For example, by utilizing a multifocal focusing lens instead of a conventional focusing lens, benefits can be obtained without adding mechanical components to an XR device and without necessitating relative displacement between optical assembly elements.

According to some examples, the presently described devices, systems, or methodologies provide an improvement to an operation of the functioning of a computer by providing an XR device that can better address the VAC and/or provide improved display features. One or more of the methodologies described herein may obviate a need for certain efforts or computing resources. Examples of such computing resources include processor cycles, network traffic, memory usage, data storage capacity, power consumption, network bandwidth, and cooling capacity.

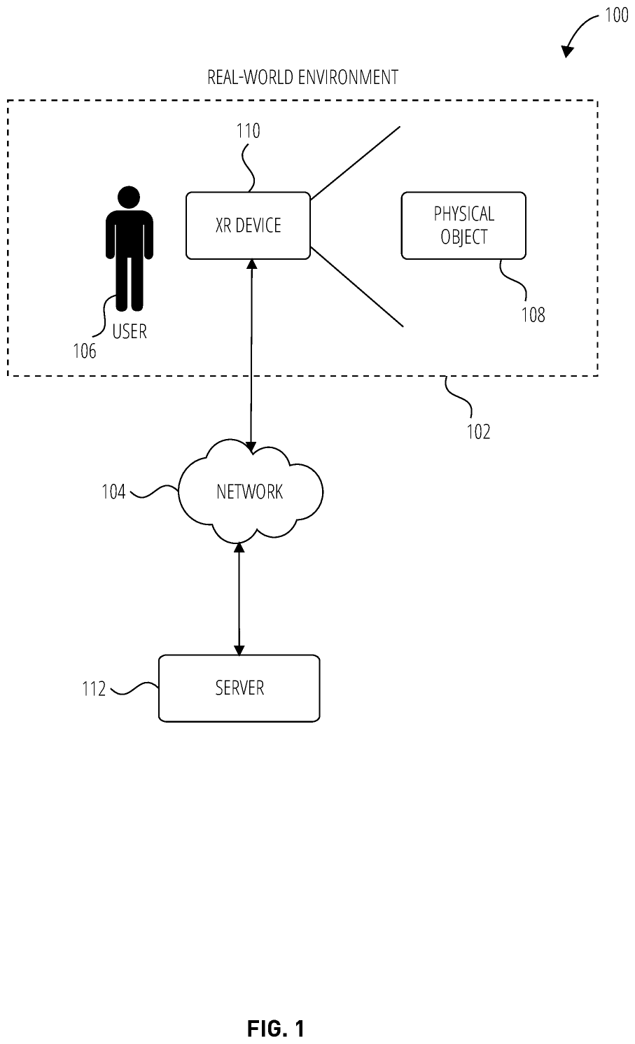

FIG. 1 is a network diagram illustrating a network environment 100 suitable for operating an XR device 110, according to some examples. The network environment 100 includes an XR device 110 and a server 112, communicatively coupled to each other via a network 104. The server 112 may be part of a network-based system. For example, the network-based system can be or include a cloud-based server system that provides additional information, such as virtual content (e.g., 3D models of virtual objects, or augmentations to be applied as virtual overlays onto images depicting real-world scenes) to the XR device 110.

A user 106 operates the XR device 110. The user 106 may be a human user (e.g., a human being), a machine user (e.g., a computer configured by a software program to interact with the XR device 110), or any suitable combination thereof (e.g., a human assisted by a machine or a machine supervised by a human).

The user 106 is not part of the network environment 100, but is associated with the XR device 110. For example, where the XR device 110 is a head-wearable apparatus, the user 106 wears the XR device 110 during a user session.

The XR device 110 may have different display arrangements. In some examples, the display arrangement may include a screen that displays virtual content and/or what is captured with a camera of the XR device 110. In some examples, the display arrangement is an OST arrangement. The screen may be positioned in the gaze path of the user or offset from the gaze path of the user.

In some examples, the user 106 operates an application of the XR device 110, referred to herein as an AR application. The AR application may be configured to provide the user 106 with an experience triggered or enhanced by a physical object 108, such as a two-dimensional (2D) physical object (e.g., a picture), a 3D physical object (e.g., a statue), a location (e.g., at factory), or references (e.g., perceived corners of walls or furniture, or digital codes) in a real-world environment 102. For example, the user 106 can point a camera of the XR device 110 to capture an image of the physical object 108 and a virtual overlay may be presented over the physical object 108 via the display.

Experiences may also be triggered or enhanced by a hand or other body part of the user 106. For example, the XR device 110 may detect and respond to hand gestures or signals. When using some XR devices, such as head-wearable devices (also referred to as head-mounted devices, or “HMDs”), the hand of the user serves as an interaction tool. As a result, the hand is often “visible” to the XR device 110, with virtual content being rendered to appear on or close to the hand.

The XR device 110 includes tracking components (not shown in FIG. 1). The tracking components track the pose (e.g., position and orientation) of the XR device 110 relative to the real-world environment 102 using image sensors (e.g., depth-enabled 3D camera and image camera), inertial sensors (e.g., gyroscope, accelerometer, or the like), wireless sensors (e.g., Bluetooth™ or Wi-Fi™), a Global Positioning System (GPS) sensor, and/or audio sensor to determine the location of the XR device 110 within the real-world environment 102. In some examples, the tracking components track the pose of the hand (or hands) of the user 106 or some other physical object 108 in the real-world environment 102.

In some examples, the server 112 is used to detect and identify the physical object 108 based on sensor data (e.g., image and depth data) from the XR device 110, and determine a pose of the XR device 110, the physical object 108 and/or the hand of the user 106 based on the sensor data. The server 112 can also generate virtual content based on the pose of the XR device 110, the physical object 108, and/or the hand.

In some examples, the server 112 communicates virtual content (e.g., a virtual object) to the XR device 110. The XR device 110 or the server 112, or both, can perform image processing, object detection, and object tracking functions based on images captured by the XR device 110 and one or more parameters internal or external to the XR device 110.

The object recognition, tracking, and content rendering can be performed on either the XR device 110, the server 112, or a combination between the XR device 110 and the server 112. Accordingly, while certain functions are described herein as being performed by either an XR device or a server, the location of certain functionality may be a design choice (unless specifically indicated to the contrary). For example, it might be technically preferable to deploy particular technology and functionality within a server system initially, but later to migrate this technology and functionality to a client installed locally at the XR device where the XR device has sufficient processing capacity.

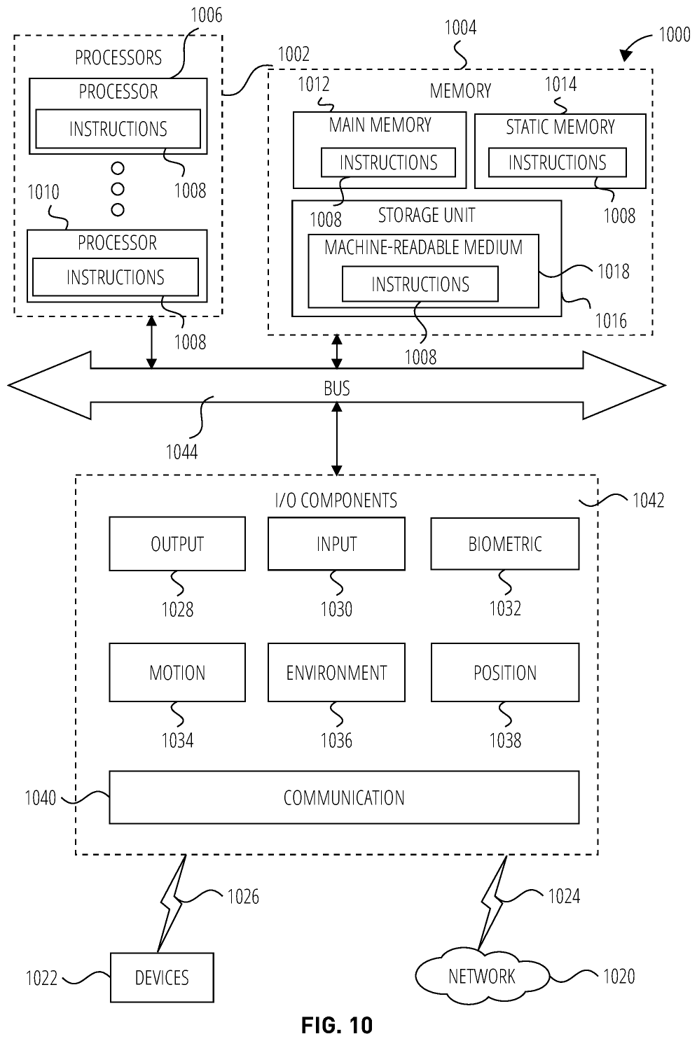

One or more of the machines, components, or devices shown in FIG. 1 may be implemented in a general-purpose computer modified (e.g., configured or programmed) by software to be a special-purpose computer to perform one or more of the functions described herein for that machine, database, or device. For example, a computer system able to implement any one or more of the methodologies described herein is discussed below with respect to FIG. 10. Moreover, two or more of the machines, components, or devices illustrated in FIG. 1 may be combined into a single machine, component, or device, and the functions described herein for any single machine, component, or device may be subdivided among multiple machines, components, or devices.

The network 104 may be any network that enables communication between or among machines (e.g., server 112), databases, or devices (e.g., XR device 110). Accordingly, the network 104 may be a wired network, a wireless network (e.g., a mobile or cellular network), or any suitable combination thereof. The network 104 may include one or more portions that constitute a private network, a public network (e.g., the Internet), or any suitable combination thereof.

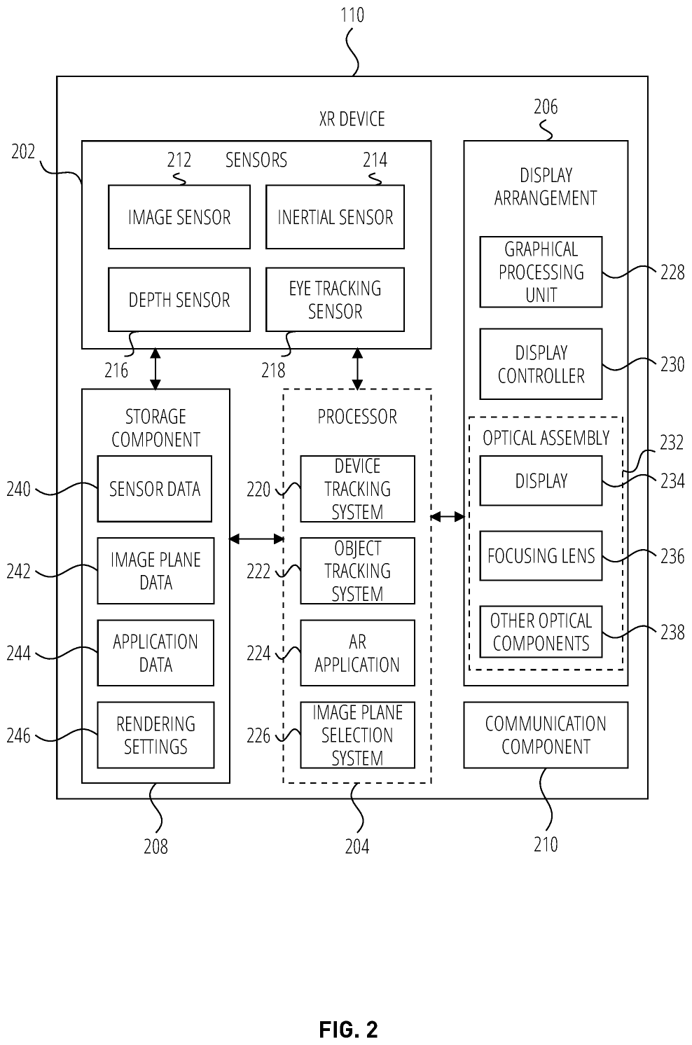

FIG. 2 is a block diagram illustrating components (e.g., modules, parts, or systems) of the XR device 110 of FIG. 1, according to some examples. The XR device 110 is shown in FIG. 2 to include sensors 202, a processor 204, a display arrangement 206, a storage component 208, and a communication component 210. It will be appreciated that FIG. 2 is not intended to provide an exhaustive indication of components of the XR device 110.

The sensors 202 include one or more image sensors 212, one or more inertial sensors 214, one or more depth sensors 216, and one or more eye tracking sensors 218. The image sensor 212 can include, for example, a combination of a color camera, a thermal camera, a depth sensor, and one or multiple grayscale, global shutter tracking cameras.

In some examples, the inertial sensor 214 includes a combination of a gyroscope, accelerometer, and a magnetometer. In some examples, the inertial sensor 214 includes one or more Inertial Measurement Units (IMUs). An IMU enables tracking of movement of a body by integrating the acceleration and the angular velocity measured by the IMU. An IMU can include a combination of accelerometers and gyroscopes that can determine and quantify linear acceleration and angular velocity, respectively. The values obtained can be processed to obtain the pitch, roll, and heading of the IMU and, therefore, of the body with which the IMU is associated. Signals from the accelerometers of the IMU also can be processed to obtain velocity and displacement. The IMU may also include one or more magnetometers.

The depth sensor 216 may include one or a combination of a structured-light sensor, a time-of-flight sensor, passive stereo sensor, or an ultrasound device. The eye tracking sensor 218 is configured to monitor the gaze direction of the user, providing data for various applications, such as determining where to render virtual content of an AR application 224. The XR device 110 may include one or multiple of these sensors, such as infrared eye tracking sensors, corneal reflection tracking sensors, or video-based eye-tracking sensors.

Other examples of sensors 202 include a proximity or location sensor (e.g., near field communication, GPS, Bluetooth™, or Wi-Fi™), an audio sensor (e.g., a microphone), or any suitable combination thereof. It is noted that the sensors 202 described herein are for illustrative purposes and the sensors 202 are thus not limited to the ones described above.

The processor 204 executes or facilitates implementation of a device tracking system 220, an object tracking system 222, the AR application 224, and an image plane selection system 226.

The device tracking system 220 estimates a pose of the XR device 110. For example, the device tracking system 220 uses data from the image sensor 212 and the inertial sensor 214 to track a location and pose of the XR device 110 relative to a frame of reference (e.g., real-world environment 102). In some examples, the device tracking system 220 uses sensor data from the sensors 202 to determine the pose of the XR device 110. The pose may be a determined orientation and position of the XR device 110 in relation to the user's real-world environment 102.

In some examples, the device tracking system 220 continually gathers and uses updated sensor data describing movements of the XR device 110 to determine updated poses of the XR device 110 that indicate changes in the relative position and orientation of the XR device 110 from the physical objects in the real-world environment 102. In some examples, the device tracking system 220 provides the pose of the XR device 110 to a graphical processing unit 228 of the display arrangement 206.

The object tracking system 222 enables the tracking of an object, such as the physical object 108 of FIG. 1, or a hand of a user. The object tracking system 222 may include a computer-operated application or system that enables a device or system to track visual features identified in images captured by one or more image sensors, such as one or more cameras. In some examples, the object tracking system builds a model of a real-world environment based on the tracked visual features. An object tracking system may implement one or more object tracking machine learning models to track an object in the field of view of a user during a user session. The object tracking machine learning model may comprise a neural network trained on suitable training data to identify and track objects in a sequence of frames captured by the XR device 110. The object tracking machine learning model may use an object's appearance, motion, landmarks, and/or other features to estimate location in subsequent frames.

In some examples, the device tracking system 220 and/or the object tracking system 222 implements a “SLAM” (Simultaneous Localization and Mapping) system to understand and map a physical environment in real-time. This allows, for example, the XR device 110 to accurately place digital objects in the real world and track their position as a user moves and/or as objects move. The XR device 110 may include a “VIO” (Visual-Inertial Odometry) system that combines data from an IMU and a camera to estimate the position and orientation of an object in real-time.

The AR application 224 may retrieve virtual content, such as a virtual object (e.g., 3D object model) or other augmentation, based on an identified physical object 108, physical environment (or other real-world feature), or user input (e.g., a detected gesture). The graphical processing unit 228 of the display arrangement 206 causes display of the virtual object, augmentation, or the like.

In some examples, the AR application 224 includes a local rendering engine that generates a visualization of a virtual object overlaid (e.g., superimposed upon, mixed with, or otherwise displayed in tandem with) on an image of the physical object 108 (or other real-world feature) captured by the image sensor 212. A visualization of the virtual object may be manipulated by adjusting a position of the physical object or feature (e.g., its physical location, orientation, or both) relative to the image sensor 212. Similarly, the visualization of the virtual object may be manipulated by adjusting a pose of the XR device 110 relative to the physical object or feature.

The display arrangement 206 may further include a display controller 230, one or more displays 234, a focusing lens 236, and other optical components 238. In some examples, the display 234, the focusing lens 236, and/or other optical components 238 are part of an optical assembly 232 designed to guide, direct, manipulate, and/or focus light representing virtual content to the eyes of the user.

Referring generally to the optical assembly 232, the optical assembly 232 may include various optical components. The optical assembly 232 may include one or more display components and one or more lenses, mirrors, waveguides, filters, diffusers, or prisms, which work together to present virtual content to the user. The design of the optical assembly 232 can vary depending on the desired field of view, image clarity, and form factor of the XR device 110.

The display 234 may include a screen or panel configured to display images generated by the processor 204 or the graphical processing unit 228. The display 234 may include one or more components or devices to present images, videos, or graphics to a user. The display 234 may be an electronic screen. Technologies such as LCDs, organic light-emitting diodes (OLEDs), micro-LEDs, or projection-based systems may be incorporated into the display 234.

In some examples, the display 234 may be transparent or semi-transparent so that the user 106 can see through the display 234. In other examples, the display 234 is offset from a gaze path of the user, with the other optical components 238 (e.g., a half-mirror, waveguide, or beam splitter) directing light from the display 234 into the gaze path.

Optical lenses may be used to adjust the presentation of the virtual content to the user's eye. For example, where the display 234 comprises a projector system that projects images onto a near-eye display surface of the XR device 110, lenses can be placed on a user-facing side and/or an exterior side of the display surface to modulate the image plane in front of the user's eye where the virtual content appears (e.g., to adjust the perceived distance of the virtual content from the user's eye). A near user-facing side lens (also called an eye-side lens) affects the perceived distance of the virtual content in front of the user (e.g., the image plane); while an exterior side lens (also called a world-side lens) is provided to neutralize the effect of the near side lens on real-world objects. In some examples, an ophthalmic lens can also be positioned on the eye side to allow users needing visual correction to correctly perceive the virtual content.

Referring again to the optical assembly 232, the focusing lens 236 is an example of an optical element that can focus light originating from the display 234 such that the user perceives images at a certain depth (e.g., at a predetermined image plane). In some examples, the XR device 110 includes at least one focusing lens 236 in the form of a multifocal lens that directs light such that virtual content is presented to the user at multiple image planes at different focus distances. In some examples, the multiple image planes are determined by a predetermined mapping between viewing zones of the display 234 and portions of the at least one focusing lens 236, as described elsewhere herein.

Referring again to the graphical processing unit 228, the graphical processing unit 228 may include a render engine that is configured to render a frame of a 3D model of a virtual object based on the virtual content provided by the AR application 224 and the pose of the XR device 110 (and, in some cases, the position of a tracked object). In other words, the graphical processing unit 228 uses the pose information as well as predetermined content data to generate frames of virtual content to be presented on the display 234. For example, the graphical processing unit 228 uses the pose to render a frame of the virtual content such that the virtual content is presented at an orientation and position in the display 234 to properly augment the user's reality.

As an example, the graphical processing unit 228 may use the pose data to render a frame of virtual content such that, when presented on the display 234, the virtual content is caused to be presented to a user so as to overlap with a physical object in the user's real-world environment 102. The graphical processing unit 228 can generate updated frames of virtual content based on updated poses of the XR device 110 and updated tracking data generated by the abovementioned tracking components, which reflect changes in the position and orientation of the user in relation to physical objects in the user's real-world environment 102, thereby resulting in a more immersive experience.

In some examples, the XR device 110 uses predetermined properties of a virtual object (e.g., an object model with certain dimensions, textures, transparency, and colors) along with lighting estimates and pose data to render virtual content within an XR environment in a way that is visually coherent with the real-world lighting conditions.

In some examples, the XR device 110 is configured to take into account characteristics of a virtual object and properties of the optical assembly 232 to determine in which viewing zone of the display 234 to render the virtual object. For example, the image plane selection system 226 may identify a presentation distance of the virtual object. For example, a virtual apple to be rendered on the hand of the user may have a presentation distance of 70 cm (about 2.3 ft), while a virtual scoreboard for a sporting event may have a presentation distance of 10 m. For the virtual apple, the image plane selection system 226 matches the presentation distance with a viewing zone of the display 234 based on the focus distance at which that viewing zone will be presented to the user.

For example, and assuming a bifocal example of the focusing lens 236, the graphical processing unit 228 communicates with the image plane selection system 226 and then generates the virtual apple in a lower section of the display 234 since the lower section's light is directed through a portion of the focusing lens 236 that causes virtual content to appear close to the user (e.g., at a near-view image plane). On the other hand, the image plane selection system 226 matches the presentation distance of the virtual scoreboard with another viewing zone of the display 234, and then instructs the graphical processing unit 228 to generate the virtual scoreboard in an upper section of the display 234 since the upper section's light is directed through a different portion of the focusing lens 236 that causes virtual content to appear farther away from the user (e.g., at a far-view image plane).

The image plane selection system 226 may thus be used to leverage a multifocal optical assembly, such as the optical assembly 232, by causing content to be selectively rendered at a particular image plane and/or focus distance. The image plane selection system 226 may be configured to perform these selections to make virtual content appear as natural and/or realistic as possible and to mitigate the VAC.

Referring again to the display arrangement 206, the graphical processing unit 228 transfers a rendered frame (with the virtual content to which the aforementioned processing has been applied) to the display controller 230. In some examples, the display controller 230 is positioned as an intermediary between the graphical processing unit 228 and the display 234, receives the image data (e.g., rendered frame) from the graphical processing unit 228, re-projects the frame (by performing a warping process) based on a latest pose of the XR device 110 (and, in some cases, object tracking pose forecasts or predictions), and provides the re-projected frame to the display 234.

It will be appreciated that, in examples where an XR device includes multiple displays, each display may have a dedicated graphical processing unit and/or display controller and/or optical assembly. It will further be appreciated that where an XR device includes multiple displays, e.g., in the case of AR glasses or another AR device that provides binocular vision to mimic the way humans naturally perceive the world, a left eye display arrangement and a right eye display arrangement may deliver separate images or video streams to each eye. Where an XR device includes multiple displays, steps may be carried out separately and substantially in parallel for each display and/or optical assembly, in some examples, and pairs of features or components may be included to cater for both eyes.

For example, an XR device may capture separate images for a left eye display and a right eye display (or for a set of right eye displays and a set of left eye displays), and render separate outputs for each eye to create a more immersive experience and to adjust the focus and convergence of the overall view of a user for a more natural, 3D view. Thus, while a single set of display arrangement components may be discussed to describe some examples, e.g., a display 234 and focusing lens 236 that direct images to one eye, similar techniques may be applied to cover both eyes by providing a further set of display arrangement components.

The storage component 208 may store various data, such as sensor data 240, image plane data 242, application data 244, and rendering settings 246. In some examples, some of the data of the storage component 208 is stored at the XR device 110 while other data is stored at the server 112.

Sensor data 240 may include data obtained from one or more of the sensors 202, such as image frames captured by the cameras and IMU data including inertial measurements. Image plane data 242 may include specifications and/or characteristics of virtual content as it should appear on an image plane from the user's perspective. The image plane data 242 may include details of image planes supported by the XR device 110, and on the position, scale, and focus of virtual objects, ensuring they are rendered correctly within the user's field of view. For instance, if the user is viewing a virtual coffee cup on a table, the image plane data 242 may ensure that the cup appears at the correct size and location on the table, as if it were a real object.

Application data 244 may include content and instructions provided by the software applications running on the XR device 110, such as the AR application 224. This data may include user interface elements, 3D models, textures, animations, and interactive elements that the user will engage with in the virtual environment. The XR device 110 may process the application data 244 together with the image plane data 242 to determine where and how to render virtual content.

Rendering settings 246 may include parameters and options used by the XR device 110 to render and display virtual content. The rendering settings 246 may determine visual quality, performance, or rendering techniques used to generate the virtual environment. Examples of rendering settings may include resolution, frame rate, shading models, visual fidelity, performance parameters, and lighting techniques. Accordingly, the rendering settings 246 may include configuration data stored within the storage component 208 that regulates how virtual content is rendered by the XR device 110 (e.g., via the graphical processing unit 228).

The communication component 210 of the XR device 110 enables connectivity and data exchange. For example, the communication component 210 enables wireless connectivity and data exchange with external networks and servers, such as the server 112 of FIG. 1. This can allow certain functions described herein to be performed at the XR device 110 and/or at the server 112.

The communication component 210 may allow the XR device 110 to transmit and receive data, including software updates, machine learning models, and cloud-based processing tasks. In some examples, the communication component 210 facilitates the offloading of computationally intensive tasks to the server 112. Additionally, the communication component 210 can allow for synchronization or networking with other devices in a multi-user XR environment, enabling participants to have a consistent and collaborative experience (e.g., in a multi-player AR game or an AR presentation mode).

In some examples, at least some of the components shown in FIG. 2 are configured to communicate with each other to implement aspects described herein. One or more of the components described may be implemented using software, hardware (e.g., one or more processors of one or more machines), or a combination of hardware and software. For example, a component described herein may be implemented by a processor configured to perform the operations described herein for that component. Moreover, two or more of these components may be combined into a single component, or the functions described herein for a single component may be subdivided among multiple components. Furthermore, according to various examples, components described herein may be implemented using a single machine, database, or device, or be distributed across multiple machines, databases, or devices.

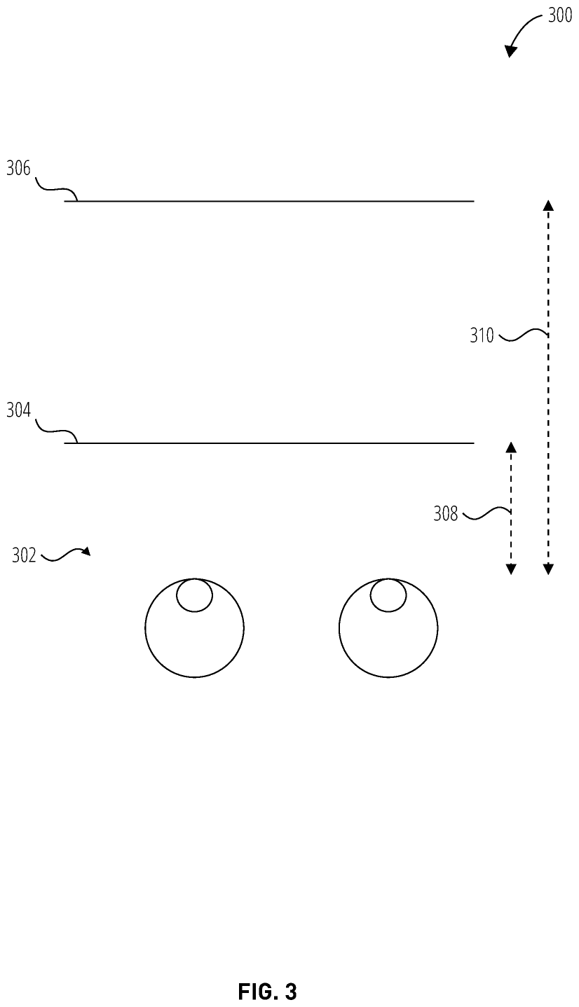

Turning now to FIG. 3, a diagram 300 is shown to depict the eyes 302 of a user (e.g., the user 106 of FIG. 1), as well as a first image plane 304 and a second image plane 306 associated with an XR device (e.g., the XR device 110 of FIG. 1) worn by the user, according to some examples.

The first image plane 304 is located a first focus distance 308 from the XR device (e.g., from the eyes 302 or a point on the XR device that is near the eyes 302) and the second image plane 306 is located at a second focus distance 310 from the XR device (farther away from the eyes 302). In some examples, the focus distances 308, 310 are fixed, and thus also the image planes 304, 306. For example, the first focus distance 308 can be fixed at 60 cm or 80 cm, and the second focus distance 310 can be fixed at 3 m, 5 m, or 10 m.

Such a configuration may be obtained by utilizing a multifocal optical assembly, such as the optical assembly 232 of the FIG. 2. For example, the focusing lens 236 of the optical assembly 232 can be bifocal in that it includes a first portion with first focusing characteristics (e.g., curvature attributes and refractive properties) and a second portion with second focusing characteristics, different from the first portion. Light traveling through the first portion is directed and focused so as to provide virtual content that is in focus at the first image plane 304 (from the viewing perspective of the eyes 302). Light traveling through the second portion is directed and focused so as to provide virtual content that is in focus at the second image plane 306 (also from the viewing perspective of the eyes 302).

The XR device can be configured to selectively display virtual content on viewing zones of a display (e.g., the display 234) corresponding to particular portions of the focusing lens 236, thereby ensuring that respective virtual content items are presented at desired focus distances.

While FIG. 3, as well as other examples herein, illustrate a bifocal optical configuration within an XR device, it is noted that such a configuration is a non-limiting example and that the present disclosure is not restricted to bifocal configurations that provide two image planes. For example, a multifocal optical assembly can be designed to include more than two image planes, each corresponding to a specific portion of the lens with unique focusing characteristics (e.g., a large number of planes can be provided where the focusing lens 236 has progressive focusing characteristics). For example, in addition to the first image plane 304 and the second image plane 306, additional image planes can be incorporated to cater to intermediate distances or to address specific visual tasks within an XR environment.

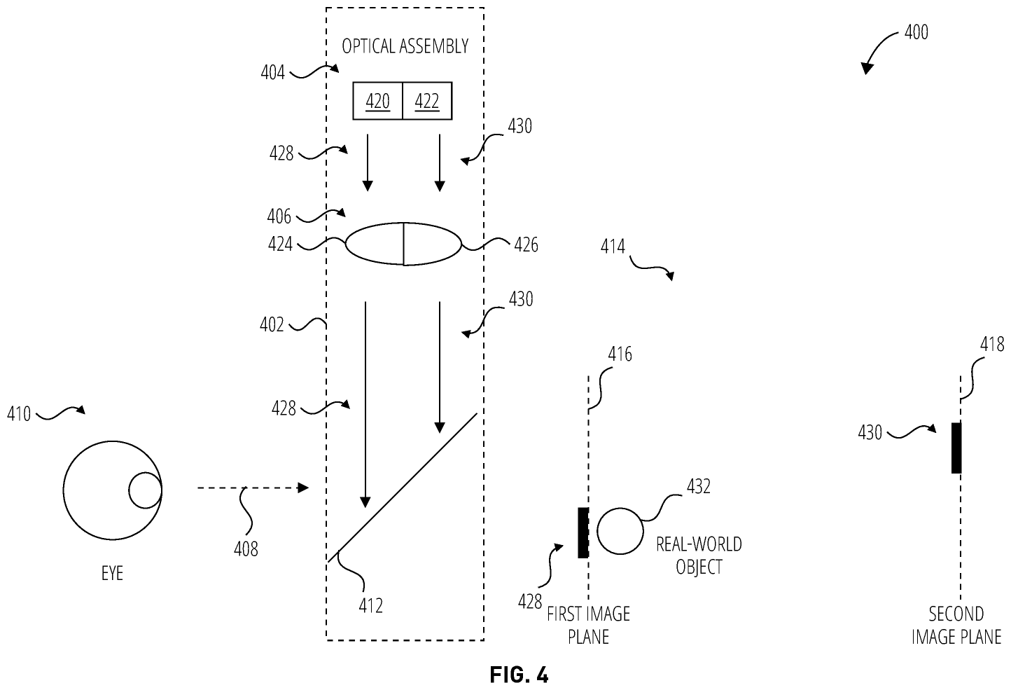

Referring now to FIG. 4, a diagram 400 is shown to illustrate the manner in which an optical assembly 402 can be used to generate virtual content to be perceived clearly at different image planes associated with an XR device (e.g., the XR device 110) worn by a user (e.g., the user 106), according to some examples.

In FIG. 4, the optical assembly 402 includes a screen 404 (as an example of the display 234 of FIG. 2) and a focusing lens 406 (as an example of the focusing lens 236 of FIG. 2). It will be appreciated that FIG. 4 is not intended to provide an exhaustive indication of components of the optical assembly 402. For example, an optical assembly may typically include multiple lenses, and the single focusing lens 406 is shown and described to illustrate certain aspects of the present disclosure. For instance, in addition to the focusing lens 406, the optical assembly 402 might include one or more further lenses for collimating light.

In the diagram 400 of FIG. 4, the optical assembly 402 is that of an OST display arrangement. The screen 404 is offset from a gaze path 408 of the user, as illustrated by the directional arrow and the eye 410 shown in FIG. 4. In other words, the screen 404 is not directly in the view of the user when the user is wearing the XR device. Instead, the optical assembly 402 includes a half-mirror 412 (as an example of an optical combiner) to direct light originating from the display from an optical path into the gaze path 408 to enable the user to view both virtual content and features of a real-world environment 414.

From an optical perspective, the screen 404 may be regarded as the origin point or zone for virtual content within the XR device. The screen 404 is responsible for displaying images that will be superimposed onto or mixed into the user's view of the real-world environment 414. In a bifocal setup, such as the one shown in FIG. 4, the screen 404 displays content that is intended to be seen at two different focus distances, corresponding, respectively, to a first image plane 416 and a second image plane 418. For example, one portion of the screen 404, which may be referred as a first viewing zone 420, can display content designed to be in focus when viewed up close, such as text, fine details or hand-interaction objects, while another portion of the screen 404, which may be referred to as a second viewing zone 422, displays content intended for viewing at a distance, such as environmental cues or distant objects.

From the viewing perspective of the user, the first viewing zone 420 can be in an upper section of the screen 404 while the second viewing zone 422 is in a lower section of the screen 404.

The focusing lens 406 is positioned in the optical path between the screen 404 and the user's eye 410. The focusing lens 406 is bifocal, meaning it has two regions providing different focus distances. A first portion 424 of the focusing lens 406 corresponds to the near-focus content displayed in the first viewing zone 420 of the screen 404, while a second portion 426 corresponds to the far-focus content in the second viewing zone 422 of the screen 404. In other words, zones or portions with different characteristics are included in the same lens.

As light from the screen 404 passes through the focusing lens 406, it is refracted differently depending on which region of the focusing lens 406 it traverses. This refraction ensures that the virtual content will appear at the correct focus distance (e.g., either at the first image plane 416 or at the second image plane 418), providing the user with a visual experience that mimics natural sight.

The half-mirror 412 combines the virtual content from the screen 404 with the real-world view of the real-world environment 414. Positioned at an angle in the optical path, the half-mirror 412 reflects the light from the focusing lens 406 towards the user's eyes while simultaneously allowing light from the real-world environment 414 to pass through. This dual-action enables the virtual content to be superimposed onto the user's view of the real environment. The half-mirror 412 is also angled and positioned to ensure that both near-focus and far-focus content are correctly aligned with the user's natural gaze, depending on where they are looking.

As an example, the user may be using the AR application 224 of FIG. 2, causing the XR device to control the screen 404 to simultaneously display first virtual content 428 in the first viewing zone 420 and second virtual content 430 in the second viewing zone 422. Because the first virtual content 428 and the second virtual content 430 originate from different zones of the screen 404, the light representing them encounters differ portions of the focusing lens 406.

The light of the first virtual content 428 is directed by the first portion 424 of the focusing lens 406 such that it appears in focus at the first image plane 416, thus being clear and sharp when then user focuses relatively closely at the first image plane 416, but not when the user focuses in the distance. The light of the second virtual content 430 is directed by the second portion 426 of the focusing lens 406 such that it appears in focus at the second image plane 418, thus being clear and sharp when the user focuses at the second image plane 418 but not when the user focuses on objects closer to them.

For example, the first virtual content 428 may be a virtual object, such as a virtual apple, that is presented so as to appear in focus when the user focuses on a real-world object 432, such as their outstretched hand in the region of the first image plane 416. The second virtual content 430 would then appear relatively blurry when the user is focusing on the real-world object 432 and come into focus when the user focuses farther away in the region of the second image plane 418. By providing distinct focal points for different viewing zones, the XR device may provide a more natural experience, thereby enhancing the user's comfort and reducing eye strain, particularly during extended use.

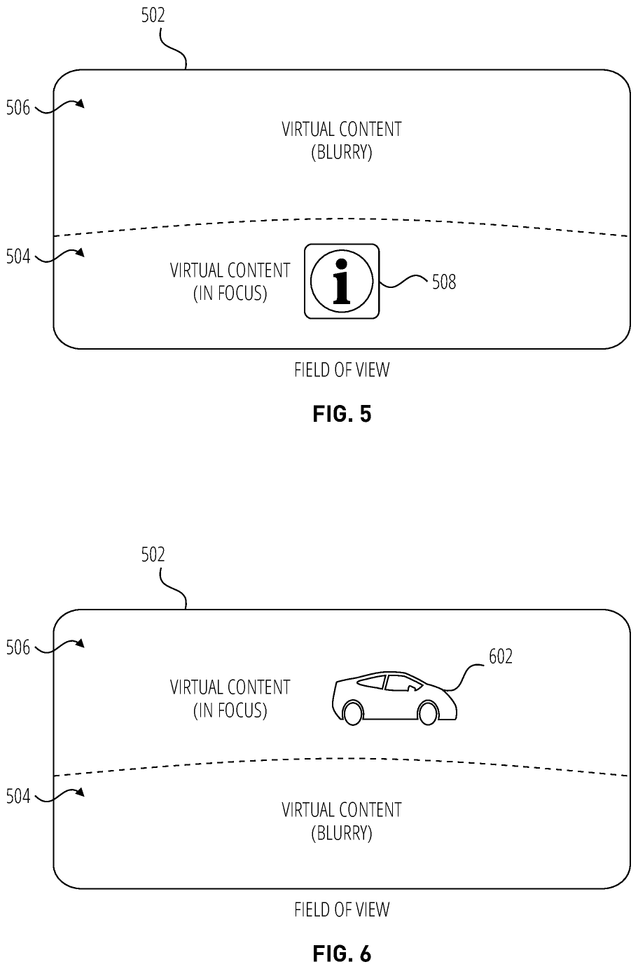

FIG. 5 and FIG. 6 are diagrammatic illustrations of a field of view 502 of a user (e.g., the user 106) wearing an XR device (e.g., the XR device 110). The field of view 502 shows the extent of the observable environment as perceived by the user, and can include real-world objects and virtual content.

In FIG. 5 and FIG. 6, the XR device has a multifocal optical assembly (e.g., the optical assembly 232) that includes a bifocal optical element (e.g., the focusing lens 236). Accordingly, the field of view 502 can be divided into two primary zones based on focus distance: a near-view zone 504 and a far-view zone 506. Within these zones, virtual content is rendered at different levels of clarity depending on the user's current focus.

The near-view zone 504 is designed to present virtual content at a closer focus distance, suitable, for instance, for objects that the user may wish to interact with directly, such as virtual objects held in the hand or placed within arm's reach. In some examples, virtual content shown in the near-view zone 504 originates from a first viewing zone of a display of the XR device (e.g., the first viewing zone 420 as depicted in FIG. 4). The near-view zone 504 might, for example, be rendered at an image plane that is 50 cm, 70 cm, or 90 cm away from the XR device, thus corresponding to a 50 cm, 70 cm, or 90 cm focus distance.

In FIG. 5, the user is focusing on a virtual object 508 in the near-view zone 504. The optical assembly of the XR device is configured such that the light from the first viewing zone of the display representing the virtual object 508 is focused through a portion of the optical element to a focus distance that corresponds to the near-view zone 504, ensuring that the virtual object 508 appears in focus to the user. As a non-limiting example, and as shown in FIG. 5, the virtual object 508 might be an informational element that the user can select with their hand (e.g., using a predetermined selection hand gesture) to view further information on a topic or item. The virtual object 508 is thus an interactive item.

The far-view zone 506 is a section of the field of view 502 intended for content that is perceived to be at a greater distance from the user. Virtual content within the far-view zone 506 is rendered to appear farther away and may be used for background elements or more distant objects that the user is not directly interacting with. Virtual content shown in the far-view zone 506 originates from a second viewing zone of the display of the XR device (e.g., the second viewing zone 422 as depicted in FIG. 4). The far-view zone 506 might, for example, be rendered at an image plane that is 3 m, 5 m, or 10 m away from the XR device, thus corresponding to a 3 m, 5 m, or 10 m focus distance.

In FIG. 5, as the user is focusing on the virtual object 508 in the near-view zone 504, virtual content (if any) in the far-view zone 506 would appear blurry, since the far-view zone 506 is presented at a different focus distance.

Referring now to FIG. 6, in FIG. 6, the user is focusing on a virtual object 602 in the far-view zone 506. The optical assembly of the XR device is configured such that the light from the second viewing zone of the display representing the virtual object 602 is focused through a portion of the optical element to a focus distance that corresponds to the far-view zone 506, ensuring that the virtual object 602 appears in focus to the user. As a non-limiting example, and as shown in FIG. 6, the virtual object 602 might be a virtual car that the user sees driving in the distance (e.g., overlaid onto a road in the real-world environment).

In FIG. 6, as the user is focusing on the virtual object 602 in the far-view zone 506, virtual content (if any) in the near-view zone 504 would appear blurry. The delineation between the near-view zone 504 and the far-view zone 506 is determined by the multifocal properties of the optical assembly within the XR device. By virtue of this configuration, virtual objects, such as the virtual object 508 and the virtual object 602, may naturally come into or out of focus, depending on where the user is focusing their eyes, and without having to configure the XR device to perform image plane adjustments during a user session (e.g., through a varifocal mechanism).

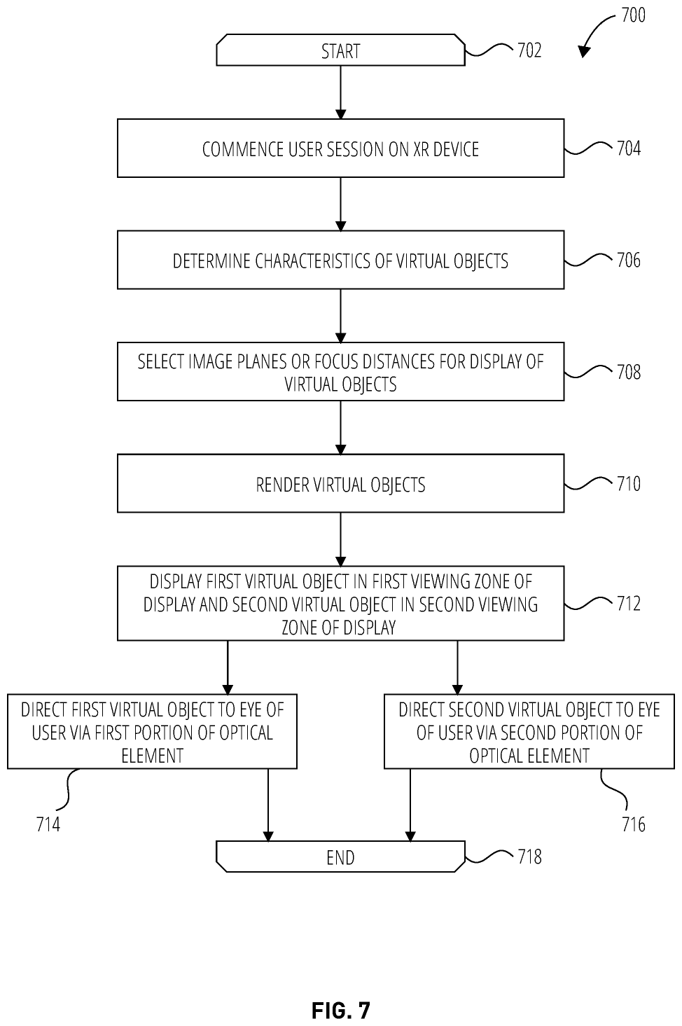

FIG. 7 is a flowchart illustrating a method 700 suitable for using an optical element to display virtual content at different focus distances, according to some examples. The method 700 may be performed by an XR device, such as the XR device 110 of FIG. 1, that has an optical assembly, such as the optical assembly 232 of FIG. 2 or the optical assembly 402 of FIG. 4. Devices and components of FIG. 1 and FIG. 2, as well as virtual content items of FIG. 5 and FIG. 6, are referred to below as non-limiting examples to illustrate the method 700.

The method 700 commences at opening loop element 702 and proceeds to operation 704, where the XR device 110 commences a user session. For example, the user 106 opens the AR application 224 to start an AR experience. As part of the AR experience, the XR device 110 displays virtual content that includes various virtual objects to the user 106.

At operation 706, the XR device 110 determines characteristics of virtual objects to be presented to the user 106. For example, the XR device 110 can determine properties of each virtual object to be presented, such as whether the virtual object is a near-view object or a background object, or whether the user 106 should be able to interact with the virtual object directly.

Characteristics can be obtained from stored data, determined in real time, or combinations thereof. For example, the XR device can execute the AR application 224 to obtain access to multiple virtual objects and their respective predetermined properties (e.g., a virtual apple or a virtual pet). The XR device 110 may also, based on object tracking and/or tracking of the XR device 110 itself, dynamically determine where in a field of view the virtual object is to be rendered. For example, the XR device 110 can determine that the virtual object should be overlaid onto a specific real-world object that is currently relatively far away from the user, or that the virtual object should be overlaid onto the outstretched hand of the user.

At operation 708, the XR device 110 selects image planes or focus distances for the display of each virtual object. In some examples, the characteristics of a virtual object, as described above, include or can be processed by the XR device 110 to provide a presentation distance that indicates how far away from the user 106 the virtual object should be perceived as being located. For example, in the case of the virtual object 508 of FIG. 5 and the virtual object 602 of FIG. 6, based on the characteristics of the virtual objects 508 and 602, the XR device 110 dynamically determines that the virtual object 508 is associated with an image plane that is relatively close to the user, and that the virtual object 602 is associated with an image plane that is relatively far away from the user.

The method 700 proceeds to operation 710, where the virtual objects are rendered. For example, the graphical processing unit 228 can obtain details of the virtual objects from the AR application 224 and/or the storage component 208, and render the virtual objects such that they will appear in the appropriate viewing zones of the display 234 to result in presentation at their respectively selected image planes. The display 234 then displays the virtual objects. For example, and as shown in FIG. 7, a first virtual object (e.g., the virtual object 508) is displayed in a first viewing zone of the display 234 and a second virtual object (e.g., the virtual object 602) is displayed in a second viewing zone of the display 234 (operation 712).

The multifocal properties of the optical assembly 232 within the XR device 110 then ensure that the virtual objects are perceived sharply and clearly at the correct depths or focus distances by the user 106. For example, and as shown in FIG. 7, the first virtual object is directed to the eye of the user 106 via a first portion of an optical element of the optical assembly 232 (operation 714) such that it appears in focus at a first image plane, and the second virtual object is directed to the eye of the user 106 via a second portion of the optical element (operation 716) such that it appears in focus at a second image plane. In some examples, the optical element is thus positioned relative to the display 234 according to a predetermined mapping between viewing zones and optical element portions.

In this way, the method 700 enables the XR device 110 to present virtual objects in a more realistic, coherent, or immersive manner. Specifically, in some examples, the method 700 can facilitate mitigation of the VAC. The method 700 concludes at closing loop element 718.

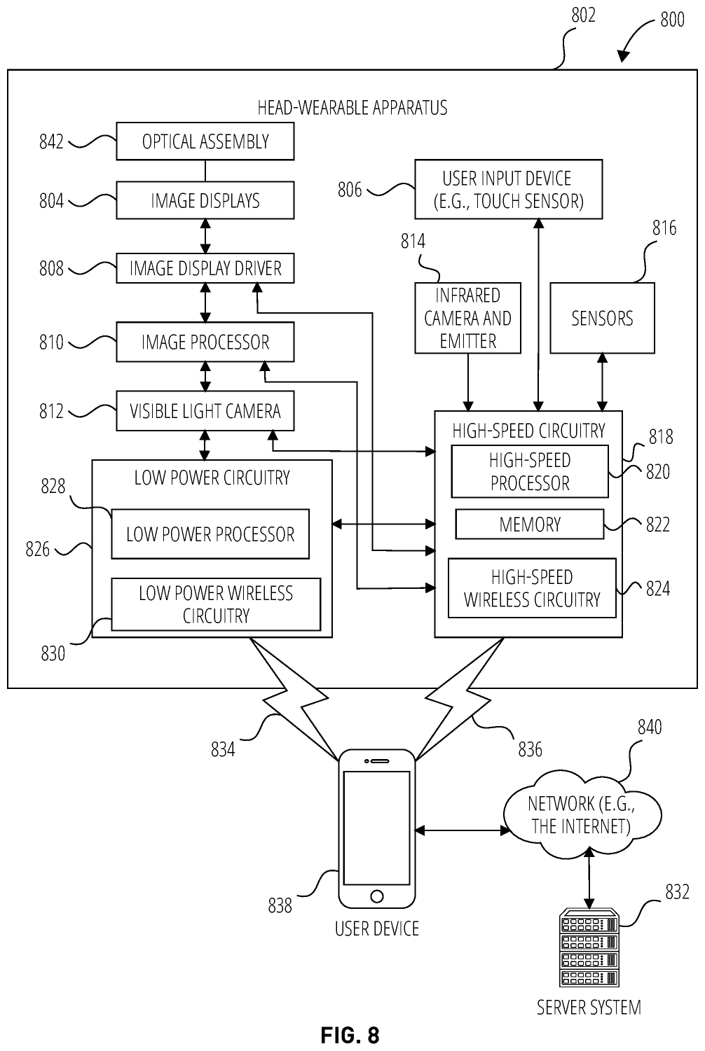

FIG. 8 illustrates a network environment 800 in which a head-wearable apparatus 802, such as a head-wearable XR device, can be implemented according to some examples. FIG. 8 provides a high-level functional block diagram of an example head-wearable apparatus 802 communicatively coupled a user device 838 and a server system 832 via a suitable network 840. One or more of the techniques described herein may be performed using the head-wearable apparatus 802 or a network of devices similar to those shown in FIG. 8.

The head-wearable apparatus 802 includes a camera, such as at least one of a visible light camera 812 and an infrared camera and emitter 814. The head-wearable apparatus 802 includes other sensors 816, such as motion sensors or eye tracking sensors. The user device 838 can be capable of connecting with head-wearable apparatus 802 using both a communication link 834 and a communication link 836. The user device 838 is connected to the server system 832 via the network 840. The network 840 may include any combination of wired and wireless connections.

The head-wearable apparatus 802 includes a display arrangement that has several components. For example, the arrangement includes two image displays 804 of an optical assembly 842. The two displays may include one associated with the left lateral side and one associated with the right lateral side of the head-wearable apparatus 802. The head-wearable apparatus 802 also includes an image display driver 808, an image processor 810, low power circuitry 826, and high-speed circuitry 818. The image displays 804 are for presenting images and videos, including an image that can provide a graphical user interface to a user of the head-wearable apparatus 802.

The image display driver 808 commands and controls the image display of each of the image displays 804. The image display driver 808 may deliver image data directly to each image display of the image displays 804 for presentation or may have to convert the image data into a signal or data format suitable for delivery to each image display device. For example, the image data may be video data formatted according to compression formats, such as H. 264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (Exif) or the like.

The images and videos may be presented to a user by directed light from the image displays 804 along respective optical paths to the eyes of the user. The head-wearable apparatus 802 may further include the optical assembly 842 to guide, direct, manipulate, and/or focus light to the eyes of the user. The optical assembly 842 may include one or more multifocal optical elements, as described in the present disclosure, to enable the head-wearable apparatus 802 to present images and video so as to be perceived at different image planes or focus distances from the user. As explained elsewhere, the optical elements can include respective portions with different focusing characteristics to effect such image planes. In some examples, virtual content (e.g., images or videos) can be presented at the same time, but at different focus distances, to mitigate the VAC.

The head-wearable apparatus 802 may include a frame and stems (or temples) extending from a lateral side of the frame, or another component (e.g., a head strap) to facilitate wearing of the head-wearable apparatus 802 by a user. The head-wearable apparatus 802 of FIG. 8 further includes a user input device 806 (e.g., touch sensor or push button) including an input surface on the head-wearable apparatus 802. The user input device 806 is configured to receive, from the user, an input selection to manipulate the graphical user interface of the presented image.

At least some components shown in FIG. 8 for the head-wearable apparatus 802 are located on one or more circuit boards, for example a printed circuit board (PCB) or flexible PCB, in the head-wearable apparatus 802. Depicted components can be located in frames, chunks, hinges, or bridges of the head-wearable apparatus 802, for example. Left and right sides of the head-wearable apparatus 802 may each include a digital camera element such as a complementary metal-oxide-semiconductor (CMOS) image sensor, charge coupled device, a camera lens, or any other respective visible or light capturing elements that may be used to capture data, including images of scenes with unknown objects.

The head-wearable apparatus 802 includes a memory 822 which stores instructions to perform a subset or all of the functions described herein. The memory 822 can also include a storage device. As further shown in FIG. 8, the high-speed circuitry 818 includes a high-speed processor 820, the memory 822, and high-speed wireless circuitry 824. In FIG. 8, the image display driver 808 is coupled to the high-speed circuitry 818 and operated by the high-speed processor 820 in order to drive the left and right image displays of the image displays 804. The high-speed processor 820 may be any processor capable of managing high-speed communications and operation of any general computing system needed for the head-wearable apparatus 802. The high-speed processor 820 includes processing resources needed for managing high-speed data transfers over the communication link 836 to a wireless local area network (WLAN) using high-speed wireless circuitry 824. In certain examples, the high-speed processor 820 executes an operating system such as a LINUX operating system or other such operating system of the head-wearable apparatus 802 and the operating system is stored in memory 822 for execution. In addition to any other responsibilities, the high-speed processor 820 executing a software architecture for the head-wearable apparatus 802 is used to manage data transfers with high-speed wireless circuitry 824. In certain examples, high-speed wireless circuitry 824 is configured to implement Institute of Electrical and Electronic Engineers (IEEE) 802.11 communication standards, also referred to herein as Wi-Fi™. In other examples, other high-speed communications standards may be implemented by high-speed wireless circuitry 824.

The low power wireless circuitry 830 and the high-speed wireless circuitry 824 of the head-wearable apparatus 802 can include short range transceivers (Bluetooth™) and wireless wide, local, or wide area network transceivers (e.g., cellular or Wi-Fi™). The user device 838, including the transceivers communicating via the communication link 834 and communication link 836, may be implemented using details of the architecture of the head-wearable apparatus 802, as can other elements of the network 840.

The memory 822 may include any storage device capable of storing various data and applications, including, among other things, camera data generated by the visible light camera 812, sensors 816, and the image processor 810, as well as images generated for display by the image display driver 808 on the image displays of the image displays 804. While the memory 822 is shown as integrated with the high-speed circuitry 818, in other examples, the memory 822 may be an independent standalone element of the head-wearable apparatus 802. In certain such examples, electrical routing lines may provide a connection through a chip that includes the high-speed processor 820 from the image processor 810 or low power processor 828 to the memory 822. In other examples, the high-speed processor 820 may manage addressing of memory 822 such that the low power processor 828 will boot the high-speed processor 820 any time that a read or write operation involving memory 822 is needed.

As shown in FIG. 8, the low power processor 828 or high-speed processor 820 of the head-wearable apparatus 802 can be coupled to the camera (visible light camera 812, or infrared camera and emitter 814), the image display driver 808, the user input device 806 (e.g., touch sensor or push button), and the memory 822. The head-wearable apparatus 802 also includes sensors 816, which may be the motion components 1034, position components 1038, environmental components 1036, and biometric components 1032, e.g., as described below with reference to FIG. 10. In particular, motion components 1034 and position components 1038 are used by the head-wearable apparatus 802 to determine and keep track of the position and orientation (the “pose”) of the head-wearable apparatus 802 relative to a frame of reference or another object, in conjunction with a video feed from one of the visible light cameras 812, using for example techniques such as structure from motion (SfM) or VIO.

In some examples, and as shown in FIG. 8, the head-wearable apparatus 802 is connected with a host computer. For example, the head-wearable apparatus 802 is paired with the user device 838 via the communication link 836 or connected to the server system 832 via the network 840. The server system 832 may be one or more computing devices as part of a service or network computing system, for example, that include a processor, a memory, and network communication interface to communicate over the network 840 with the user device 838 and head-wearable apparatus 802.

The user device 838 includes a processor and a network communication interface coupled to the processor. The network communication interface allows for communication over the network 840, communication link 834 or communication link 836. The user device 838 can further store at least portions of the instructions for implementing functionality described herein.

Output components of the head-wearable apparatus 802 include visual components, such as a display (e.g., one or more liquid-crystal display (LCD)), one or more plasma display panel (PDP), one or more light emitting diode (LED) display, one or more projector, or one or more waveguide. The image displays 804 described above are examples of such a display. In some examples, the image displays 804 of the optical assembly 842 are driven by the image display driver 808.

The output components of the head-wearable apparatus 802 may further include acoustic components (e.g., speakers), haptic components (e.g., a vibratory motor), other signal generators, and so forth. The input components of the head-wearable apparatus 802, the user device 838, and server system 832, such as the user input device 806, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 802 may optionally include additional peripheral device elements. Such peripheral device elements may include biometric sensors, additional sensors, or display elements integrated with the head-wearable apparatus 802. For example, peripheral device elements may include any I/O components including output components, motion components, position components, or any other such elements described herein.

For example, the biometric components include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi™ or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over a communication link 836 from the user device 838 via the low power wireless circuitry 830 or high-speed wireless circuitry 824.

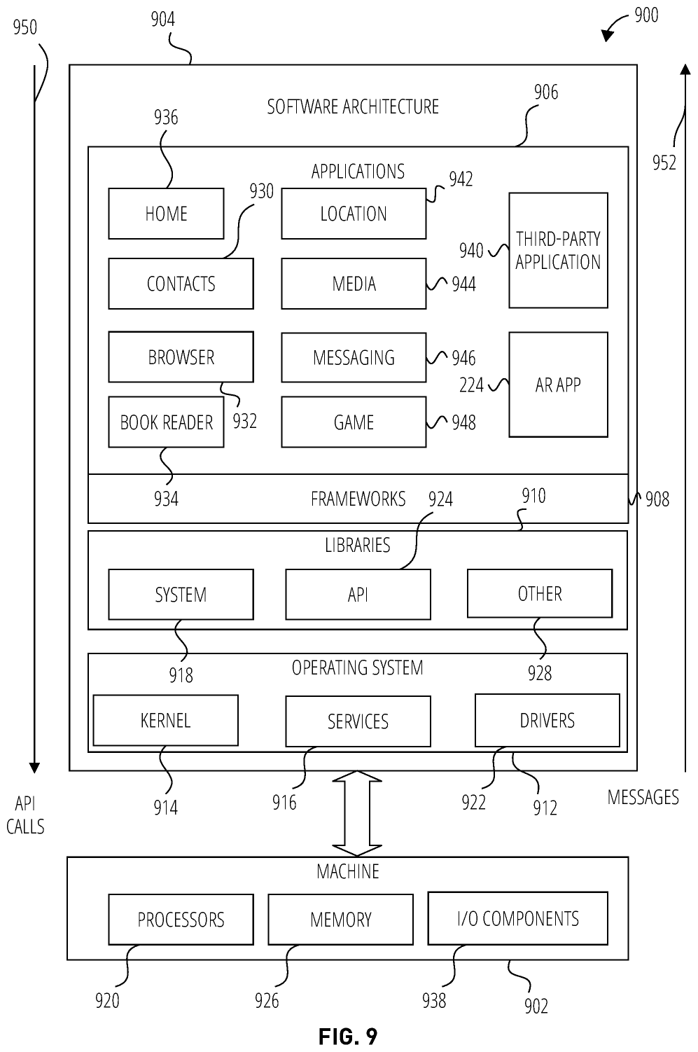

FIG. 9 is a block diagram 900 illustrating a software architecture 904, which can be installed on one or more of the devices described herein, according to some examples. The software architecture 904 is supported by hardware such as a machine 902 that includes processors 920, memory 926, and I/O components 938. In this example, the software architecture 904 can be conceptualized as a stack of layers, where each layer provides a particular functionality. The software architecture 904 includes layers such as an operating system 912, libraries 910, frameworks 908, and applications 906. Operationally, the applications 906 invoke API calls 950, through the software stack and receive messages 952 in response to the API calls 950.

The operating system 912 manages hardware resources and provides common services. The operating system 912 includes, for example, a kernel 914, services 916, and drivers 922. The kernel 914 acts as an abstraction layer between the hardware and the other software layers. For example, the kernel 914 provides memory management, processor management (e.g., scheduling), component management, networking, and security settings, among other functionality. The services 916 can provide other common services for the other software layers. The drivers 922 are responsible for controlling or interfacing with the underlying hardware. For instance, the drivers 922 can include display drivers, camera drivers, Bluetooth™ or Bluetooth™ Low Energy drivers, flash memory drivers, serial communication drivers (e.g., Universal Serial Bus (USB) drivers), Wi-Fi™ drivers, audio drivers, power management drivers, and so forth.

The libraries 910 provide a low-level common infrastructure used by the applications 906. The libraries 910 can include system libraries 918 (e.g., C standard library) that provide functions such as memory allocation functions, string manipulation functions, mathematic functions, and the like. In addition, the libraries 910 can include API libraries 924 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and 3D in a graphic content on a display), database libraries (e.g., SQLite to provide various relational database functions), web libraries (e.g., WebKit to provide web browsing functionality), and the like. The libraries 910 can also include a wide variety of other libraries 928 to provide many other APIs to the applications 906.

The frameworks 908 provide a high-level common infrastructure that is used by the applications 906. For example, the frameworks 908 provide various graphical user interface (GUI) functions, high-level resource management, and high-level location services. The frameworks 908 can provide a broad spectrum of other APIs that can be used by the applications 906, some of which may be specific to a particular operating system or platform.

In some examples, the applications 906 may include a home application 936, a contacts application 930, a browser application 932, a book reader application 934, a location application 942, a media application 944, a messaging application 946, a game application 948, and a broad assortment of other applications such as a third-party application 940. In some examples, the applications 906 are programs that execute functions defined in the programs. Various programming languages can be employed to create one or more of the applications 906, structured in a variety of manners, such as object-oriented programming languages (e.g., Objective-C, Java, or C++) or procedural programming languages (e.g., C or assembly language). In some examples, the third-party application 940 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In FIG. 9, the third-party application 940 can invoke the API calls 950 provided by the operating system 912 to facilitate functionality described herein. The applications 906 may include an AR application such as the AR application 224 described herein, according to some examples.

FIG. 10 is a diagrammatic representation of a machine 1000 within which instructions 1008 (e.g., software, a program, an application, an applet, an app, or other executable code) for causing the machine 1000 to perform any one or more of the methodologies discussed herein may be executed, according to some examples. For example, the instructions 1008 may cause the machine 1000 to execute any one or more of the methods described herein. The instructions 1008 transform the general, non-programmed machine 1000 into a particular machine 1000 programmed to carry out the described and illustrated functions in the manner described. The machine 1000 may operate as a standalone device or may be coupled (e.g., networked) to other machines.

In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), XR device, a smart home device (e.g., a smart appliance), other smart devices, a web appliance, a network router, a network switch, a network bridge, or any machine capable of executing the instructions 1008, sequentially or otherwise, that specify actions to be taken by the machine 1000. Further, while only a single machine 1000 is illustrated, the term “machine” shall also be taken to include a collection of machines that individually or jointly execute the instructions 1008 to perform any one or more of the methodologies discussed herein.

The machine 1000 may include processors 1002, memory 1004, and I/O components 1042, which may be configured to communicate with each other via a bus 1044. In some examples, the processors 1002 may include, for example, a processor 1006 and a processor 1010 that execute the instructions 1008. Although FIG. 10 shows multiple processors 1002, the machine 1000 may include a single processor with a single core, a single processor with multiple cores (e.g., a multi-core processor), multiple processors with a single core, multiple processors with multiples cores, or any combination thereof.

The memory 1004 includes a main memory 1012, a static memory 1014, and a storage unit 1016, accessible to the processors via the bus 1044. The main memory 1004, the static memory 1014, and storage unit 1016 store the instructions 1008 embodying any one or more of the methodologies or functions described herein. The instructions 1008 may also reside, completely or partially, within the main memory 1012, within the static memory 1014, within machine-readable medium 1018 within the storage unit 1016, within at least one of the processors, or any suitable combination thereof, during execution thereof by the machine 1000.

The I/O components 1042 may include a wide variety of components to receive input, provide output, produce output, transmit information, exchange information, capture measurements, and so on. The specific I/O components 1042 that are included in a particular machine will depend on the type of machine. For example, portable machines such as mobile phones may include a touch input device or other such input mechanisms, while a headless server machine will likely not include such a touch input device. It will be appreciated that the I/O components 1042 may include many other components that are not shown in FIG. 10. In various examples, the I/O components 1042 may include output components 1028 and input components 1030. The output components 1028 may include visual components (e.g., a display such as a plasma display panel (PDP), a light emitting diode (LED) display, a LCD, a projector, or a cathode ray tube (CRT)), acoustic components (e.g., speakers), haptic components (e.g., a vibratory motor, resistance mechanisms), other signal generators, and so forth. The input components 1030 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In some examples, the I/O components 1042 may include biometric components 1032, motion components 1034, environmental components 1036, or position components 1038, among a wide array of other components. For example, the biometric components 1032 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1034 include acceleration sensor components (e.g., accelerometer), gravitation sensor components, rotation sensor components (e.g., gyroscope), and so forth. The environmental components 1036 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1038 include location sensor components (e.g., a GPS receiver components), altitude sensor components (e.g., altimeters or barometers that detect air pressure from which altitude may be derived), orientation sensor components (e.g., magnetometers), and the like.

Any biometric data collected by the biometric components is captured and stored with only user approval and deleted on user request. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the biometric data is not shared or sold to any third party without the explicit consent of the user. In addition, appropriate technical and organizational measures are implemented to ensure the security and confidentiality of this sensitive information.

Communication may be implemented using a wide variety of technologies. The I/O components 1042 further include communication components 1040 operable to couple the machine 1000 to a network 1020 or devices 1022 via a coupling 1024 and a coupling 1026, respectively. For example, the communication components 1040 may include a network interface component or another suitable device to interface with the network 1020. In further examples, the communication components 1040 may include wired communication components, wireless communication components, cellular communication components, Near Field Communication (NFC) components, Bluetooth™ components, Wi-Fi™ components, and other communication components to provide communication via other modalities. The devices 1022 may be another machine or any of a wide variety of peripheral devices (e.g., a peripheral device coupled via a USB).

Moreover, the communication components 1040 may detect identifiers or include components operable to detect identifiers. For example, the communication components 1040 may include Radio Frequency Identification (RFID) tag reader components, NFC smart tag detection components, optical reader components (e.g., an image sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1040, such as location via Internet Protocol (IP) geolocation, location via Wi-Fi™ signal triangulation, location via detecting an NFC beacon signal that may indicate a particular location, and so forth.

The various memories (e.g., memory 1004, main memory 1012, static memory 1014, and/or memory of the processors 1002) and/or storage unit 1016 may store one or more sets of instructions and data structures (e.g., software) embodying or used by any one or more of the methodologies or functions described herein. These instructions (e.g., the instructions 1008), when executed by processors 1002, cause various operations to implement the disclosed examples.

The instructions 1008 may be transmitted or received over the network 1020, using a transmission medium, via a network interface device (e.g., a network interface component included in the communication components 1040) and using any one of a number of well-known transfer protocols (e.g., hypertext transfer protocol (HTTP)). Similarly, the instructions 1008 may be transmitted or received using a transmission medium via the coupling 1026 (e.g., a peer-to-peer coupling) to the devices 1022.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks.

The terms “transmission medium” and “signal medium” mean the same thing and may be used interchangeably in this disclosure. The terms “transmission medium” and “signal medium” shall be taken to include any intangible medium that is capable of storing, encoding, or carrying the instructions for execution by the machine 1000, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

### CONCLUSION

Although aspects have been described with reference to specific examples, it will be evident that various modifications and changes may be made to these examples without departing from the broader scope of the present disclosure. Accordingly, the specification and drawings are to be regarded in an illustrative rather than a restrictive sense. The accompanying drawings that form a part hereof, show by way of illustration, and not of limitation, specific examples in which the subject matter may be practiced. The examples illustrated are described in sufficient detail to enable those skilled in the art to practice the teachings disclosed herein. Other examples may be utilized and derived therefrom, such that structural and logical substitutions and changes may be made without departing from the scope of this disclosure. This Detailed Description, therefore, is not to be taken in a limiting sense, and the scope of various examples is defined only by the appended claims, along with the full range of equivalents to which such claims are entitled.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

As used herein, the term “processor” may refer to any one or more circuits or virtual circuits (e.g., a physical circuit emulated by logic executing on an actual processor) that manipulates data values according to control signals (e.g., commands, opcodes, machine code, control words, macroinstructions, etc.) and which produces corresponding output signals that are applied to operate a machine. A processor may, for example, include at least one of a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), a Tensor Processing Unit (TPU), a Neural Processing Unit (NPU), a Vision Processing Unit (VPU), a Machine Learning Accelerator, an Artificial Intelligence Accelerator, an Application Specific Integrated Circuit (ASIC), an FPGA, a Radio-Frequency Integrated Circuit (RFIC), a Neuromorphic Processor, a Quantum Processor, or any combination thereof. A processor may be a multi-core processor having two or more independent processors (sometimes referred to as “cores”) that may execute instructions contemporaneously. Multi-core processors may contain multiple computational cores on a single integrated circuit die, each of which can independently execute program instructions in parallel. Parallel processing on multi-core processors may be implemented via architectures like superscalar, Very Long Instruction Word (VLIW), vector processing, or Single Instruction, Multiple Data (SIMD) that allow each core to run separate instruction streams concurrently. A processor may be emulated in software, running on a physical processor, as a virtual processor or virtual circuit. The virtual processor may behave like an independent processor but is implemented in software rather than hardware.

Unless the context clearly requires otherwise, in the present disclosure, the words “comprise,” “comprising,” and the like are to be construed in an inclusive sense, as opposed to an exclusive or exhaustive sense, e.g., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

The various features, steps, operations, and processes described herein may be used independently of one another, or may be combined in various ways. All possible combinations and subcombinations are intended to fall within the scope of this disclosure. In addition, certain method or process blocks or operations may be omitted in some implementations.

Although some examples, such as those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in examples for the purpose of streamlining the disclosure. This method of disclosure is not to be interpreted as reflecting an intention that the examples require more features than are expressly recited in each claim. Rather, inventive subject matter may reside in less than all features of a single disclosed example.

### Examples

In view of the above-described implementations of subject matter this application discloses the following list of examples, wherein one feature of an example in isolation, or more than one feature of an example taken in combination, and, optionally, in combination with one or more features of one or more further examples, are further examples also falling within the disclosure of this application.

Example 1 is a head-wearable extended reality (XR) device that includes, an optical assembly, the optical assembly comprising: a display to display virtual content to a user of the XR device; and an optical element to direct the virtual content from the display along an optical path towards an eye of the user, the optical element comprising at least a first portion and a second portion, the first portion providing a first focus distance that corresponds to a first viewing zone of the display and the second portion providing a second focus distance that differs from the first focus distance and corresponds to a second viewing zone of the display.

In Example 2, the subject matter of Example 1 includes, wherein the optical element comprises a lens.

In Example 3, the subject matter of Example 2 includes, wherein the lens is arranged in a fixed position relative to the display.

In Example 4, the subject matter of any of Examples 2-3 includes, wherein the lens is a fixed-focus focusing lens.

In Example 5, the subject matter of any of Examples 2-4 includes, wherein the lens is a bifocal focusing lens.

In Example 6, the subject matter of any of Examples 2-5 includes, wherein the lens is a trifocal focusing lens, and the lens further comprises a third portion providing a third focus distance that corresponds to a third viewing zone of the display, the third focus distance differing from both the first focus distance and the second focus distance.

In Example 7, the subject matter of any of Examples 2-6 includes, wherein the lens is a progressive focusing lens comprising a plurality of portions in addition to the first portion and the second portion, and each of the plurality of portions provides a different focus distance that corresponds to a respective viewing zone of the display, thereby defining multiple focus distances distributed across a field of view.

In Example 8, the subject matter of Example 7 includes, wherein the multiple focus distances are distributed according to a gradient.

In Example 9, the subject matter of any of Examples 1-8 includes, wherein the virtual content comprises first virtual content and second virtual content, wherein the display is to simultaneously display the first virtual content in the first viewing zone and the second virtual content in the second viewing zone, and the optical assembly is to direct, via the optical element, the first virtual content to be displayed at the first focus distance and the second virtual content to be displayed at the second focus distance.

In Example 10, the subject matter of any of Examples 1-9 includes, wherein the virtual content comprises a virtual object, and the XR device further comprises at least one processor to: determine a presentation distance associated with the virtual object; assign, based on the presentation distance, the first focus distance to the virtual object; and in response to the assignment of the first focus distance to the virtual object, cause the virtual object to be rendered in the first viewing zone of the display.

In Example 11, the subject matter of any of Examples 1-10 includes, wherein the virtual content comprises first virtual content from the first viewing zone and second virtual content from the second viewing zone, wherein the optical element is configured such that the first portion operatively directs the first virtual content such that the first virtual content is perceived at a first image plane at the first focus distance, and the second portion operatively directs the second virtual content such that the second virtual content is perceived at a second image plane at the second focus distance, the first image plane being located in front of the second image plane from a viewing perspective of the user.

In Example 12, the subject matter of Example 11 includes, wherein the first virtual content comprises a first virtual object and the second virtual content comprises a second virtual object, and the XR device further comprises at least one processor to: identify, based on characteristics of the first virtual object and the second virtual object, that the first virtual object is to be presented at the first image plane and the second virtual content is to be presented at the second image plane; and in response to identifying that the first virtual object is to be presented at the first image plane and the second virtual content is to be presented at the second image plane, cause the first virtual object to be rendered in the first viewing zone and the second virtual object to be rendered in the second viewing zone.

In Example 13, the subject matter of any of Examples 11-12 includes, wherein, from the viewing perspective of the user, the first viewing zone is located in a lower section of a field of view and the second viewing zone is located in an upper section of the field of view.

In Example 14, the subject matter of any of Examples 1-13 includes, wherein the first focus distance and the second focus distance are fixed distances.

In Example 15, the subject matter of any of Examples 1-14 includes, wherein the first focus distance is a first distance selected for hand-based interactions with the XR device, and the second focus distance is a second distance that is greater than the first distance.

In Example 16, the subject matter of any of Examples 1-15 includes, wherein the optical assembly forms part of an optical see-through (OST) display arrangement.

In Example 17, the subject matter of Example 16 includes, wherein the display is offset from a gaze path of the XR device, and the OST display arrangement further comprises an optical combiner to direct light originating from the display from the optical path into the gaze path to enable the user to view the virtual content.

In Example 18, the subject matter of any of Examples 1-17 includes, wherein the optical assembly is a first optical assembly and the eye of the user is a first eye of the user, and the XR device further includes a second optical assembly for a second eye of the user.

Example 19 is an optical assembly for a head-wearable extended reality (XR) device, the optical assembly comprising: a display to display virtual content to a user of the XR device; and an optical element to direct the virtual content from the display along an optical path to an eye of the user, the optical element comprising at least a first portion and a second portion, the first portion providing a first focus distance that corresponds to a first viewing zone of the display and the second portion providing a second focus distance that differs from the first focus distance and corresponds to a second viewing zone of the display.

Example 20 is a method performed by a head-wearable extended reality (XR) device that includes, an optical assembly, the method comprising: displaying first virtual content in a first viewing zone of a display of the optical assembly; directing, via a first portion of an optical element of the optical assembly, the first virtual content along an optical path to an eye of a user such that the first virtual content is displayed at a first focus distance; displaying second virtual content in a second viewing zone of the display; and directing, via a second portion of the optical element, the second virtual content along the optical path such that the second virtual content is displayed at a second focus distance that differs from the first focus distance.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

What is claimed is:

1. A head-wearable extended reality (XR) device that includes an optical assembly, the optical assembly comprising:
a display to display virtual content to a user of the XR device; and
an optical element to direct the virtual content from the display along an optical path towards an eye of the user, the optical element comprising at least a first portion and a second portion, the first portion providing a first focus distance that corresponds to a first viewing zone of the display and the second portion providing a second focus distance that differs from the first focus distance and corresponds to a second viewing zone of the display.

2. The XR device of claim 1, wherein the optical element comprises a lens.

3. The XR device of claim 2, wherein the lens is arranged in a fixed position relative to the display.

4. The XR device of claim 2, wherein the lens is a fixed-focus focusing lens.

5. The XR device of claim 2, wherein the lens is a bifocal focusing lens.

6. The XR device of claim 2, wherein the lens is a trifocal focusing lens, and the lens further comprises a third portion providing a third focus distance that corresponds to a third viewing zone of the display, the third focus distance differing from both the first focus distance and the second focus distance.

7. The XR device of claim 2, wherein the lens is a progressive focusing lens comprising a plurality of portions in addition to the first portion and the second portion, and each of the plurality of portions provides a different focus distance that corresponds to a respective viewing zone of the display, thereby defining multiple focus distances distributed across a field of view.

8. The XR device of claim 7, wherein the multiple focus distances are distributed according to a gradient.

9. The XR device of claim 1, wherein the virtual content comprises first virtual content and second virtual content, wherein the display is to simultaneously display the first virtual content in the first viewing zone and the second virtual content in the second viewing zone, and the optical assembly is to direct, via the optical element, the first virtual content to be displayed at the first focus distance and the second virtual content to be displayed at the second focus distance.

10. The XR device of claim 1, wherein the virtual content comprises a virtual object, and the XR device further comprises at least one processor to:
determine a presentation distance associated with the virtual object;
assign, based on the presentation distance, the first focus distance to the virtual object; and
in response to the assignment of the first focus distance to the virtual object, cause the virtual object to be rendered in the first viewing zone of the display.

11. The XR device of claim 1, wherein the virtual content comprises first virtual content from the first viewing zone and second virtual content from the second viewing zone, wherein the optical element is configured such that the first portion operatively directs the first virtual content such that the first virtual content is perceived at a first image plane at the first focus distance, and the second portion operatively directs the second virtual content such that the second virtual content is perceived at a second image plane at the second focus distance, the first image plane being located in front of the second image plane from a viewing perspective of the user.

12. The XR device of claim 11, wherein the first virtual content comprises a first virtual object and the second virtual content comprises a second virtual object, and the XR device further comprises at least one processor to:
identify, based on characteristics of the first virtual object and the second virtual object, that the first virtual object is to be presented at the first image plane and the second virtual content is to be presented at the second image plane; and
in response to identifying that the first virtual object is to be presented at the first image plane and the second virtual content is to be presented at the second image plane, cause the first virtual object to be rendered in the first viewing zone and the second virtual object to be rendered in the second viewing zone.

13. The XR device of claim 11, wherein, from the viewing perspective of the user, the first viewing zone is located in a lower section of a field of view and the second viewing zone is located in an upper section of the field of view.

14. The XR device of claim 1, wherein the first focus distance and the second focus distance are fixed distances.

15. The XR device of claim 1, wherein the first focus distance is a first distance selected for hand-based interactions with the XR device, and the second focus distance is a second distance that is greater than the first distance.

16. The XR device of claim 1, wherein the optical assembly forms part of an optical see-through (OST) display arrangement.

17. The XR device of claim 16, wherein the display is offset from a gaze path of the XR device, and the OST display arrangement further comprises an optical combiner to direct light originating from the display from the optical path into the gaze path to enable the user to view the virtual content.

18. The XR device of claim 1, wherein the optical assembly is a first optical assembly and the eye of the user is a first eye of the user, and the XR device further includes a second optical assembly for a second eye of the user.

19. An optical assembly for a head-wearable extended reality (XR) device, the optical assembly comprising:
a display to display virtual content to a user of the XR device; and
an optical element to direct the virtual content from the display along an optical path to an eye of the user, the optical element comprising at least a first portion and a second portion, the first portion providing a first focus distance that corresponds to a first viewing zone of the display and the second portion providing a second focus distance that differs from the first focus distance and corresponds to a second viewing zone of the display.

20. A method performed by a head-wearable extended reality (XR) device that includes an optical assembly, the method comprising:
displaying first virtual content in a first viewing zone of a display of the optical assembly;
directing, via a first portion of an optical element of the optical assembly, the first virtual content along an optical path to an eye of a user such that the first virtual content is displayed at a first focus distance;
displaying second virtual content in a second viewing zone of the display; and
directing, via a second portion of the optical element, the second virtual content along the optical path such that the second virtual content is displayed at a second focus distance that differs from the first focus distance.
